(19) United States
(12) Patent Application Publication
(10) Pub. No.: US 2023/0322149 A1
(43) Pub. Date: Oct. 12, 2023

(54) RECESSED LOCKING MECHANISM FOR TRANSPORT VEHICLES

(71) Applicant: Bush Specialty Vehicles, Inc., Wilmington, OH (US)

(72) Inventors: Larry Vanover, Maineville, OH (US); Shannon Edmiston, Seaman, OH (US)

(21) Appl. No.: 18/298,762

(22) Filed: Apr. 11, 2023

Related U.S. Application Data
(60) Provisional application No. 63/362,834, filed on Apr. 12, 2022.

(51) Int. Cl. B60P 7/08

(52) U.S. Cl. CPC B60P 7/0807

(57) ABSTRACT

A locking mechanism for use in a vehicle includes an arm, a hub connected to the arm, a linkage connected to the hub, and a locking claw connected to the linkage. Operation of the arm causes a movement of the hub and a corresponding movement of the linkage. The corresponding movement of the linkage causes a position of the locking claw to change, such that the locking claw emerges from or submerges into a cavity in a floor or a side wall of the vehicle.

### PRIORITY CLAIM

The present application claims priority to U.S. Provisional Patent Application No. 63/362,834, which has a filing date of Apr. 12, 2022, and which is expressly incorporated herein by reference.

### FIELD OF THE INVENTION

The present invention relates to locking devices used to secure loads or equipment within retrofitted or outfitted vehicles. More particularly, the present invention relates to a recessed locking mechanism that resides within a cavity or cavities in the floor or sidewall of a vehicle and can be operated to emerge from the cavity or cavities to anchor cargo in place.

### BACKGROUND OF THE INVENTION

Service and transport vehicles must be loaded with cargo which is often mounted on pallets. Service and transport vehicles may include railcars, transport aircraft, semi-trailers, service vans, and/or the like. In some situations, such as when the cargo is heavy, the pallets can be loaded into the vehicle using a forklift. However, in service and transport vehicles such as semi-trailers, rail cars, and service vans, forklifts may only be able to partially load cargo into the vehicle because the rear of the vehicle obstructs the path of the forklift. For this reason, a system of recessed rollers has been commonly used in such vehicles to enable a person to enter the vehicle and manually push the cargo to the position where the cargo is intended to be anchored.

Once the cargo is in position to be anchored, the person anchors the cargo by driving a threaded bolt into a corresponding hole using a power drill or an air-powered impact wrench. However, this method often leads to stripping of the bolt and/or damaging the corresponding hole. For example, the bolt may be stripped and/or the corresponding hole may be damaged due to overuse, misalignment of the pallet with the hole, and/or carelessness by overpowering the bolt with power tools.

In addition, traditional anchoring systems and methods for securing cargo in vehicles require select, pre-determined holes to be bored into the floor of the vehicle. This limits the versatility afforded to traditional anchoring systems based on the size and type of pallet being used. For example, a vehicle that ordinarily hosts three pallets may not be used to host any number of pallets greater than three because there would be insufficient anchoring locations. To provide another example, a system that is outfitted to host a certain pallet that possesses certain dimensions would be unable to host a different pallet without further intrusion on the floor and the creation of additional anchoring holes.

Furthermore, traditional anchoring systems require a greater amount of time for a person to manually insert each bolt into each anchoring hole and to manually fasten each bolt down. Workers who short-cut this requirement in hopes of speeding up their efforts could ultimately damage the cargo by misaligning the anchoring holes, by failing to fasten all the bolts in place, or by losing bolts altogether. In extreme scenarios, this presents a danger to the cargo as well as the vehicle operator and/or passenger(s) in the event the load is not properly anchored and begins shifting during transit.

Accordingly, there is a need for a more durable, efficient, and safe way to anchor cargo in vehicles without compromising the integrity of the vehicle.

### SUMMARY OF THE INVENTION

The present invention provides a locking mechanism for cargo and a method for anchoring cargo in vehicles. The invention utilizes a locking mechanism that can be activated or deactivated by performing a single operation. The single operation can be performed by a worker and/or can be performed autonomously. The locking mechanism includes an arm, a hub connected to the arm, a linkage connected to the hub, and a locking claw connected to the linkage.

The locking mechanism may be activated through operation of the arm. For example, operation of the arm involves having a user push or pull on the arm, thereby causing a movement of the hub of the locking mechanism and a corresponding movement of the linkage. The corresponding movement of the linkage causes a change in a position of the locking claw, such that the locking claw emerges from a cavity in a floor (or in a side wall) of a vehicle. Specifically, the user pushing or pulling the arm creates a first force that causes the movement of the hub and the corresponding movement of the linkage. The corresponding movement of the linkage creates a second force that causes the change in the position of the locking claw.

As such, operation of the arm will align the locking claw with a corresponding locking receiver which may be found on a cargo to be loaded in the vehicle housing the locking mechanism. A locking pin can then be inserted through the locking claw and corresponding locking receiver to secure the cargo in place within the vehicle. In this case, the locking plate is constructed to be a permanent element of a custom-built pallet—the pallet being designed to securely hold implements thereto and thus the implements to be easily and securely transported in the vehicle. In some embodiments, the locking receiver is a locking plate that has been placed on either the cargo or the pallet on which cargo is loaded.

When the locking mechanism is not in use, each respective locking claw can be safely stored. For example, each respective locking claw can be caused to descend through a respective slot such that the locking claw is stored in a cavity in the floor of the vehicle. This can be accomplished by a reciprocal, single action.

In this way, the locking mechanism is used to transport cargo in a vehicle safely and efficiently. After the cargo has been delivered, the locking pins are removed, and the locking mechanism is returned to a recessed position through a single action, thereby allowing the cargo to be unloaded.

The above and other objects and advantages of the present invention shall be made apparent from the accompanying drawings and the description thereof.

### BRIEF DESCRIPTION OF THE DRAWINGS

Like reference numerals are used to indicate like parts throughout the various drawing figures, wherein:

FIG. 1 shows an angled perspective view of a vehicle in position to receive a cargo from a forklift.

FIG. 2 shows a top view of the floor of the vehicle which contains a recessed roller track and two recessed locking mechanisms. The recessed locking mechanisms are housed in cavities beneath the floor, as shown by the presence of dotted lines.

FIG. 2A shows a longitudinal top detail view of one of the cavities that hosts a recessed locking mechanism.

FIG. 2B shows a lateral detail view of the recessed locking mechanism that is positioned within the cavity shown in FIG. 2A.

FIG. 3 shows a top view of the floor of the vehicle after the cargo has been partially loaded thereon by the forklift.

FIG. 3A shows a longitudinal top detail view of one of the cavities that hosts a recessed locking mechanism after the cargo has been partially loaded onto the floor of the vehicle.

FIG. 3B shows a lateral detail view of a recessed locking mechanism when the cargo is partially loaded onto the floor of the vehicle.

FIG. 4 shows a top view of the floor of the vehicle after the cargo has been fully loaded thereon and rolled into place.

FIG. 4A shows a longitudinal top detail view of one of the cavities that hosts a recessed locking mechanism after the cargo has been fully loaded thereon and rolled into place.

FIG. 4B shows a lateral detail view of the vehicle floor in which a recessed locking mechanism is shown, and the cargo is fully loaded on the floor of the vehicle and rolled into place.

FIG. 5 shows a top view of the floor of the vehicle after the recessed locking mechanism has been activated and the cargo has been anchored in place.

FIG. 5A shows a longitudinal top detail view of one of the cavities that hosts a recessed locking mechanism after the recessed locking mechanism has been activated and the cargo has been anchored in place.

FIG. 5B shows a lateral detail view of the recessed locking mechanism after the recessed locking mechanism has been activated and the cargo has been anchored in place.

The accompanying drawings, which are incorporated in and constitute a part of this specification, illustrate embodiments of the invention and, together with a general description of the invention given above, and the detailed description of the embodiments given below, serve to explain the principles of the invention.

### DETAILED DESCRIPTION OF THE INVENTION

In the following detailed description of several illustrative embodiments, reference is made to the accompanying drawings that form a part hereof, and in which is shown by way of illustration specific preferred embodiment in which the invention may be practiced. These embodiments are described in sufficient detail to enable those skilled in the art to practice the invention, and it is understood that other embodiments may be utilized, and that logical structural, mechanical, electrical, and other changes may be made without departing from the spirit or scope of the invention. To avoid detail not necessary to enable those skilled in the art to practice the embodiments described herein, the description may omit certain information known to those skilled in the art. The following detailed description is, therefore, not to be taken in a limiting sense, and the scope of the illustrative embodiments are defined only by the appended claims.

All patent applications, patents, and printed publications cited herein are incorporated herein by reference in the entireties, except for any subject matter disclaimers or disavowals, and except to the extent that the incorporated material is inconsistent with the express disclosure herein, in which case the language in this disclosure controls.

As used herein, the term “cargo” may refer to one or more goods that are subject to transportation by a vehicle. Additionally, or alternatively, the term “cargo” may include the structure used to house the one or more goods that are subject to transportation, such as a pallet, a container, a crate, a shipping box, and/or the like.

As used herein, “operation” of an arm of a recessed locking mechanism involves a user, system, or other autonomous implement causing a movement or actuation of the arm (e.g., by applying a pushing motion to the arm, by applying a pulling motion on the arm, and/or the like). This may cause corresponding and/or reciprocal movements of one or more other components of the recessed locking mechanism to further cause a change in a position of a locking claw of the recessed locking mechanism.

As used herein, the recessed locking mechanism may be said to be “activated,” or in an active position, after operation of the arm has caused the locking claw to emerge from a cavity in the floor of the vehicle. Similarly, the recessed locking mechanism may be said to be “deactivated,” or in an inactive position, after operation of the arm has caused the locking claw to submerge into the cavity in the floor of the vehicle.

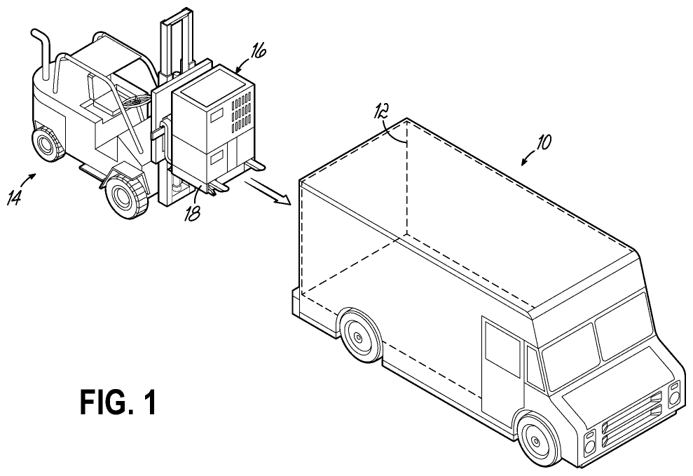

FIG. 1 shows a vehicle 10 in position to receive a cargo 16 from a forklift 14. For example, the vehicle 10 includes a rear door 12 that can be opened to permit the forklift 14 to load the cargo 16 into the vehicle 10.

Vehicle 10 is a transport and services vehicle that is used to transport individuals and/or goods. For example, the vehicle 10 may be a land-operated vehicle, such as a service van, a semi-trailer, a railcar, and/or a similar type of vehicle. While FIG. 1 shows the vehicle 10 as a more traditional type of transport and services vehicle, it is to be understood that this is provided by way of example. In practice, the vehicle 10 may be any other type of vehicle, such as an aerial vehicle (e.g., a plane, a helicopter, a drone, and/or the like), a watercraft (e.g., a motorboat, a cargo ship, a ferry, and/or the like), and/or any other type of land-operated vehicle not specified above. The vehicle 10 may include an inner storage area, which can be seen in FIG. 1 using dotted lines.

Forklift 14 is a vehicle used to load the cargo 16 into the vehicle 10. For example, the forklift 14 may be a warehouse forklift, a pallet jack, an order picker, a reach fork truck, a counterbalance forklift, a side loader, and/or another type of forklift. It is to be understood that this is provided by way of example. In practice, another type of vehicle or piece of equipment may be used to load the cargo 16 into the vehicle 10, such as a loader, a boom lift, a drone, and/or the like. For example, a drone may be configured with a means to grab the cargo 16 and/or pallet 18. In this case, the drone may, while securely holding the cargo 16 and/or pallet 18, fly into the loading zone and may release the cargo 16 and/or pallet 18 safely onto the floor of the vehicle 10.

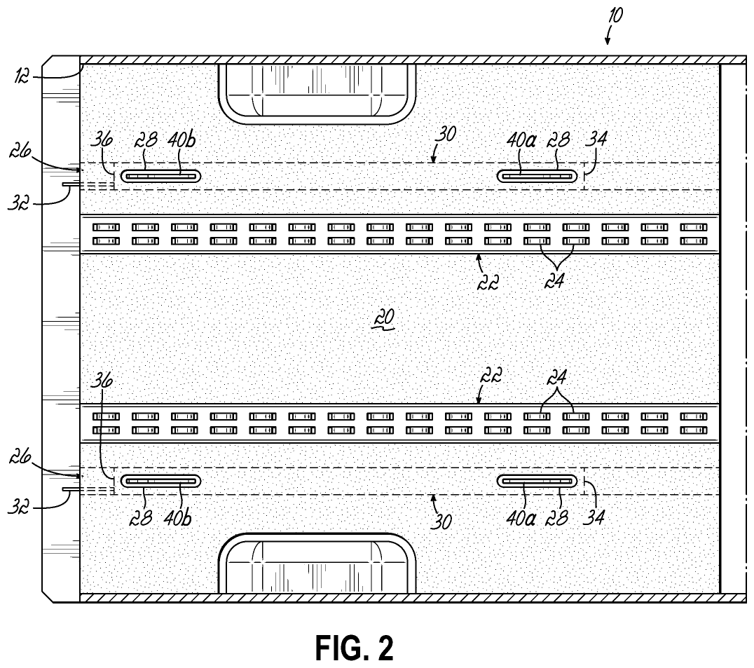

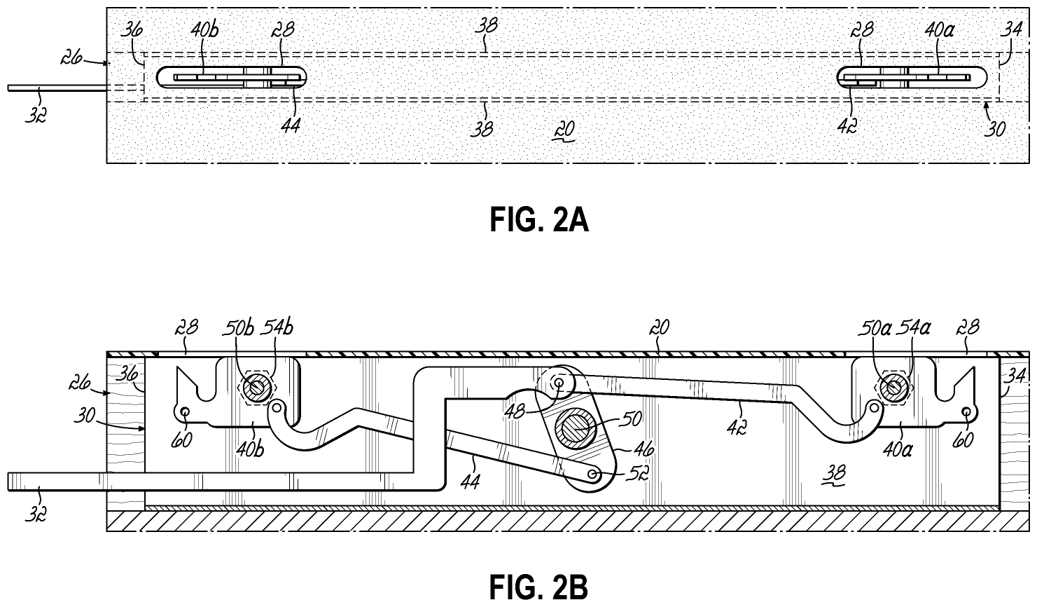

FIG. 2 shows a top view of a floor 20 of the vehicle 10. In some embodiments, a set of roller tracks 22 may be affixed to the floor 20. The set of roller tracks 22 (referred to collectively as the set of roller tracks 22 or individually as a roller track 22) may be used to move the cargo 16 and/or pallet 18 into a secure position.

In some embodiments, each respective roller track 22 may include pairs of roller track wheels 24 (referred to collectively as roller track wheels 24 or individually as a roller track wheel 24). In some embodiments, the pairs of roller track wheels 24 may be dispersed evenly throughout the length of each roller track 22. Each of the roller track wheels 24 may extend partially above the surface of the floor 20. The lower portion of each roller track wheel 24 may rest within a small roller cavity that extends downwardly below the surface of the floor 20. In other embodiments, a different roller track 22/roller track wheels 24 configuration may be utilized. For example, rather than each roller track 22 having a pair of roller track wheels 24, each roller track 22 may have a different number of roller track wheels 24. As another example, the roller track wheels 24 may be dispersed unevenly throughout the length of each roller track 22. These configurations are provided by way of example, and in practice, the cargo 16 and/or pallet 18 may be moved along the surface of the floor 20 using another device and/or system known in the art.

In some embodiments, as shown, the floor 20 may include a set of cavities 26 (referred to collectively as cavities 26 and individually as a cavity 26). Each cavity 26 cooperates with one or more slots 28 cut into the floor 20 of the vehicle 10. In some embodiments, such as the embodiment shown, there may be two slots 28 in cooperation with each respective cavity 26. These slots 28 may be cut into the floor 20. While two cavities 26 are shown, it is to be understood that this is provided by way of example. In practice, the number of cavities 26 may vary depending on the type of cargo 16 or the type of pallet 18. While four slots 28 are shown (e.g., two per cavity 26), it is to be understood that this is provided by way of example. In practice, a different number of slots 28 may be cut into each respective cavity 26 (e.g., one slot 28, three slots 28, eight slots 28, etc.).

As shown in FIG. 2, the cavities 26 are delineated using dashed hidden lines to signify the intact nature of the vehicle's floor 20 above the cavities 26. This is preferred, but not required, because there are benefits to having a fully intact floor 20, such as simpler storage for non-fastened loads, safer walking space, and a decreased risk of destruction to loads that may shift or topple during transit. Furthermore, by storing the recessed locking mechanism 30 below the surface of the floor 20 (e.g., within a cavity 26), there is a reduced risk that the recessed locking mechanism 30 is damaged or destroyed by cargo and/or pallets that are incorrectly loaded, or by un-fastened cargoes that shift or topple.

In some embodiments, each respective cavity 26 may include a recessed locking mechanism 30, which is described further herein. In some embodiments, each respective recessed locking mechanism 30 may include an arm 32. The arm 32 may be positioned at a first end 34 or a second end 36 of the recessed locking mechanism 30. In some embodiments, the arm 32 may be pushed by a user to activate the recessed locking mechanism 30.

In some embodiments, such as that shown in FIG. 2, each respective cavity 26, recessed locking mechanism 30, and/or arm 32 may be located on the outside of the roller tracks 22 (e.g., relative to a center point of the floor 20). In some embodiments, each respective cavity 26, recessed locking mechanism 30, and/or arm 32 may be located between the roller tracks 22. In some embodiments, a first set of cavities 26, a first set of recessed locking mechanisms 30, and a first set of arms 32 may be located on the outside of the roller tracks 22 while a second set of cavities 26, a second set of recessed locking mechanisms 30, and a second set of arms 32 may be located between the roller tracks 22. As used herein, the term “set” is to refer to one or more. The specific configuration implemented may depend on the width of the cargo 16 or pallet 18, the weight thereof, or a heightened need for stability.

In some embodiments, such as that shown in FIG. 1, the cargo 16 can be loaded through the rear door 12. Additionally, or alternatively, the cargo 16 may be loaded through lateral or side doors. In this case, the vehicle 10 may be equipped with the requisite number of roller tracks 22, cavities 26, recessed locking mechanisms 30, and/or arms 32 needed to safely transport the cargo 16. Additionally, one or more of the components specified above may be aligned with the lateral or side door. For this reason, a vehicle could possess perpendicularly aligned roller tracks 22, cavities 26, recessed locking mechanisms 30, and/or arms 32 so as to enable the cargo 16 to be loaded from either the rear door 12 or an alternative side door (not shown) and anchored in place using separate recessed locking mechanisms 30.

FIG. 2A shows a longitudinal top detail view of one of the cavities 26 that hosts a recessed locking mechanism 30. The boundaries of the cavity 26 may be defined using two cavity walls 38 (each wall 38 is shown using pairs of dashed hidden lines), the surface of the floor 20, and a bottommost cavity wall (not shown).

The cavity 26 that is shown includes two slots 28. Each respective slot 28 is cut into the floor 20 of the vehicle 10 to enable a locking claw, such as locking claw 40a or locking claw 40b, to emerge therefrom when the corresponding recessed locking mechanism 30 is activated. Mechanical linkages of the recessed locking mechanism 30 (shown as first linkage 42 and second linkage 44) may protrude outwardly from the slots 28 and are further described below.

FIG. 2B shows a lateral detail view of the recessed locking mechanism 30 that is positioned within the cavity 26 shown in FIG. 2A. As can be seen, the arm 32 is positioned within the cavity 26 and connects to a hub 46 via a first fastener 48. The hub 46 is fixed to a wall 38 of the cavity 26 by an axle 50. In other embodiments, the hub 46 may be fastened to the axle 50 and fixed against lateral movement through a series of bushings. In other embodiments, the axle 50 may traverse a portion of the floor 20 and simultaneously connect to a second hub 46 in a second recessed locking mechanism 30. This would enable a user to cause multiple, discreet recessed locking mechanisms 30 within the same vehicle to activate through a single operation.

FIG. 2B also shows the first linkage 42 and the second linkage 44 connected to the hub 46. The first linkage 42 is fastened to the hub 46 at the same location as the arm 32 and by the same first fastener 48. The second linkage 44 is connected to the hub at a second location through the use of a second fastener 52. This allows the first and second linkage 42, 44, to be caused to move in a forward or rearward direction depending on the direction of motion of the arm 32. Next, the first linkage 42 is connected to a first locking claw 40a and the second linkage 44 is connected to a second locking claw 40b. This connection can be accomplished by a fastener of the same type as the first fastener 48 and/or the second fastener 52. Each respective locking claw (e.g., the first locking claw 40a, the second locking claw 40b, etc.) is fixed to the wall 38 of the cavity 26 by an axle (e.g., axle 50a and axle 50b, respectively). As stated above with respect to the hub 46 and its axle 50, the axles 50a, 50b, that permit rotation of the first and second locking claws, 40a, 40b, can extend across a portion of the floor 20 and connect to second, discreet locking claws 40a, 40b, in a second, discreet recessed locking mechanism 30. In some embodiments, such as that shown, the locking claws 40a and 40b may be fixed independently to the wall 38 and axles, such as axle 50a and 50b, may be secured using corresponding axle nuts (e.g., axle nut 54a and 54b). In some embodiments, the arm 32 and the first linkage 42 may be connected at different points on the hub 46 (e.g., using different fasteners).

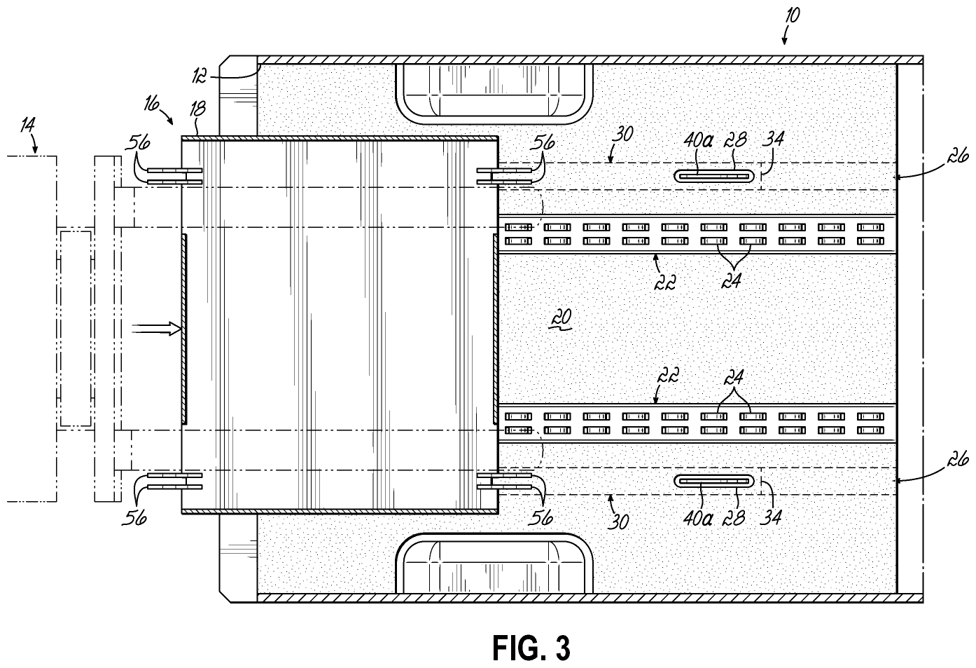

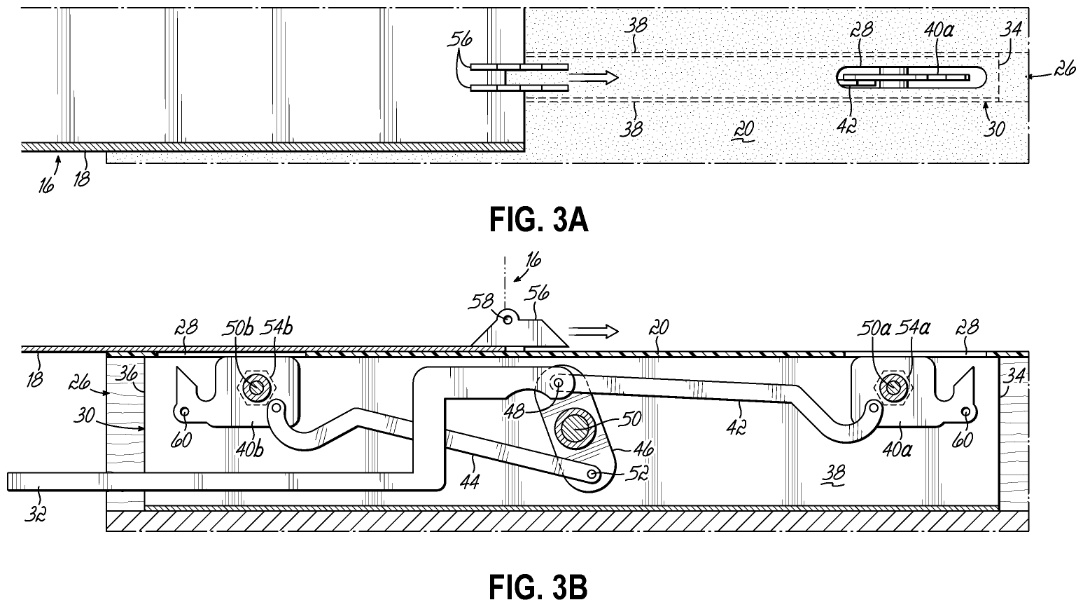

FIG. 3 shows a top view of the floor 20 of the vehicle 10 after the cargo 16 has been partially loaded thereon from the forklift 14. One or more locking receivers may be implemented to allow corresponding locking claws 40a, 40b to secure the cargo 16 and/or the pallet 18 within the vehicle 10. For example, a locking receiver may include one or more apertures that a locking claw (e.g., locking claw 40a, 40b) can be placed through or adjacent to in order to secure the cargo 16 and/or the pallet 18 within the vehicle 10.

In some embodiments, a locking receiver may be a locking plate 56 that is removably attached to the cargo 16 or to the pallet 18. In the example shown in FIG. 3, multiple locking plates 56 are attached to the cargo 16. The locking plates 56 must be arranged in a way that permits at least one locking claw (e.g., locking claw 40a, locking claw 40b, etc.) to align with a corresponding locking plate 56 when the recessed locking mechanism 30 is activated. Additionally, or alternatively, a locking receiver may be outfitted as part of the cargo 16 or the pallet 18. For example, a locking receiver may be outfitted as part of a customized piece of cargo 16 and/or as part of a customized pallet 18.

FIG. 3A shows a longitudinal top detail view of one of the cavities 26 that hosts a recessed locking mechanism 30 after the cargo 16 has been partially loaded onto the floor 20 of the vehicle 10. In some embodiments, each respective the locking plate 56 can be arranged in a way that surrounds a corresponding locking claw when the corresponding locking claw is aligned with the respective locking plate 56. For example, the arrow in FIG. 3A shows that the locking plate 56 can be pushed forward such that the locking plate 56 surrounds the first locking claw 40a. In some embodiments, the locking plate 56 can be arranged in a way that results in the locking plate 56 being adjacent to the corresponding locking claw.

FIG. 3B shows a lateral detail view of a recessed locking mechanism 30 when the cargo 16 is partially loaded onto the floor 20 of the vehicle 10. For example, FIG. 3B shows the locking plate 56 as it is being pushed towards the first end 34 of the vehicle 10. The locking plate 56 includes a locking aperture 58 which can be aligned with a locking claw aperture 60 when the locking claw (e.g., locking claw 40a, locking claw 40b, etc.) is caused to emerge from the floor 20 to align with the locking plate 56.

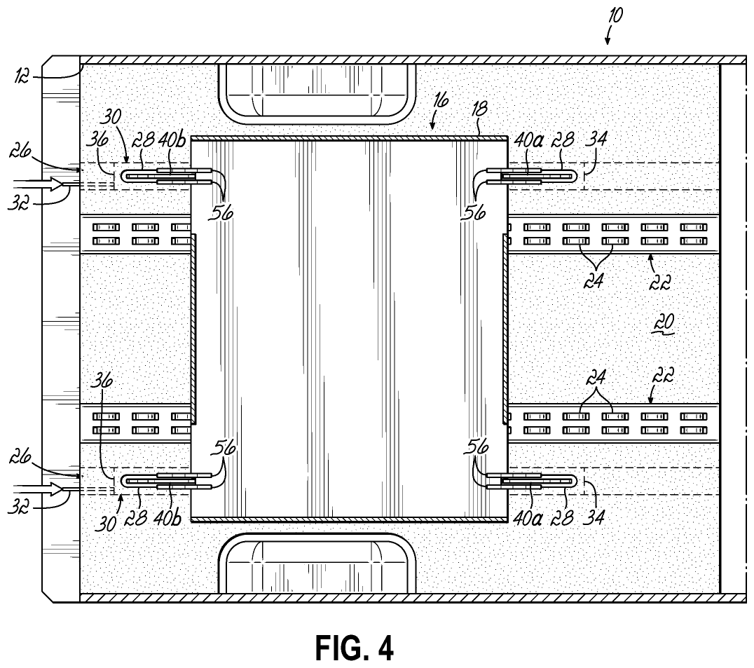

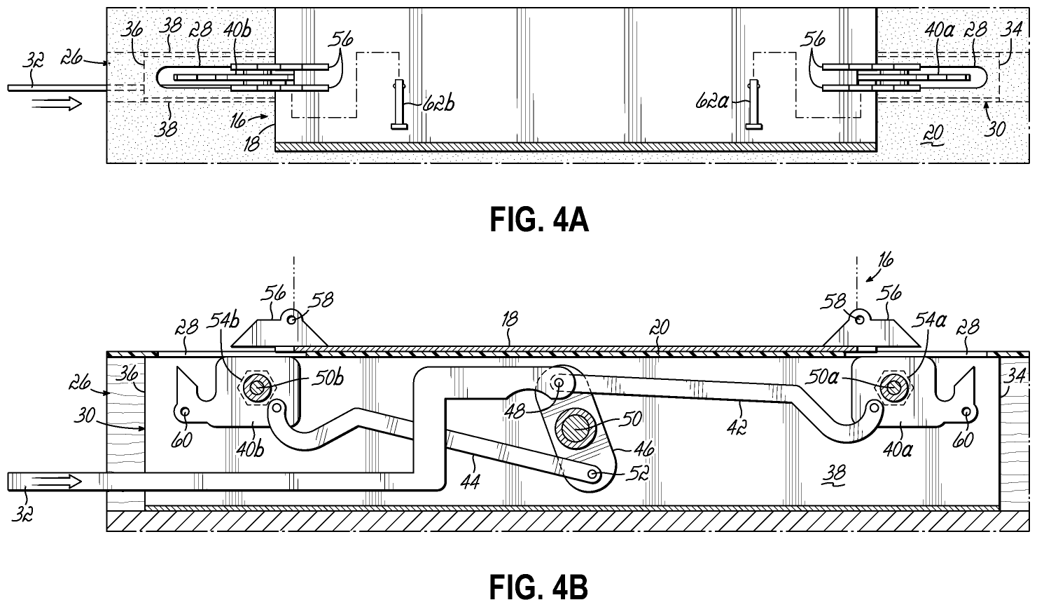

FIG. 4 shows a top view of the floor 20 of the vehicle 10 after the cargo 16 has been fully loaded thereon and rolled into place. FIG. 4A shows a longitudinal top detail view of one of the cavities 26 that hosts a recessed locking mechanism 30 after the cargo 16 has been fully loaded thereon and rolled into place. As can be seen in FIG. 4A, the slots 28 are arranged so that the locking claws 40a, 40b can emerge therefrom when the recessed locking mechanism 30 is activated. Additionally, each respective locking pin (e.g., locking pin 62a, 62b) can be inserted through the corresponding aligned locking aperture 58 and locking claw aperture 60. Locking pins 62a, 62b can be any number of fastening implements such as a lock, a bolt and nut, and/or the like.

FIG. 4B shows a lateral detail view of a recessed locking mechanism 30 when the cargo 16 is fully loaded onto the floor 20 of the vehicle 10. For example, FIG. 4B shows each respective locking plate 56 after being pushed into a position that aligns with a corresponding slot 28. This allows the locking aperture 58 of the locking plate 56 to be aligned with a corresponding locking claw aperture 60 (and subsequently locked using a corresponding locking pin 62).

In the embodiment shown, a user can push the arm 32 towards the first end 34 of the locking mechanism 30 which will cause the hub 46 to rotate on its axle 50, causing the corresponding first and second linkage 42, 44, to move distally from the hub 46 toward the first end 34 or second end 36 of the vehicle 10. This forward or rearward movement of the first and second linkage 42, 44 causes the locking claws 40a, 40b, to rotate on their respective axles 50a, 50b. The rotation of each respective locking claw (locking claw 40a, 40b) results in the locking claws emerging from the cavity 26 through a slot 28.

In some embodiments, the user can pull the arm 32 towards the first end 34 of the locking mechanism 30 which will cause the hub 46 to rotate on its axle 50, causing the corresponding first and second linkage 42, 44, to move distally from the hub 46 toward the first end 34 or second end 36 of the vehicle 10. Still, in other embodiments, operation of the arm 32 may be spring-loaded, hydraulic powered, electronically powered, or some other means of automatic actuation. The only modification that may be needed to enable such a system is the attachment of a power source to the arm 32 or to the hub 46 to permit automatic movement.

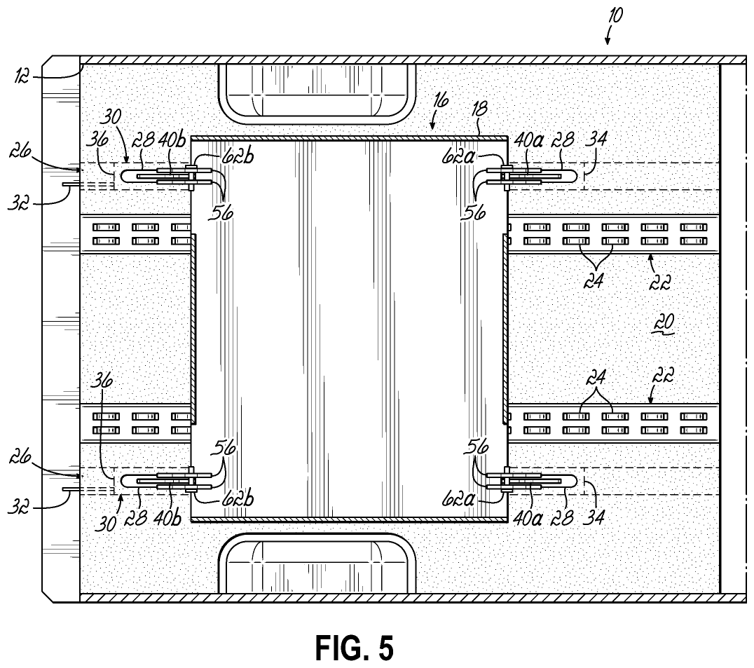

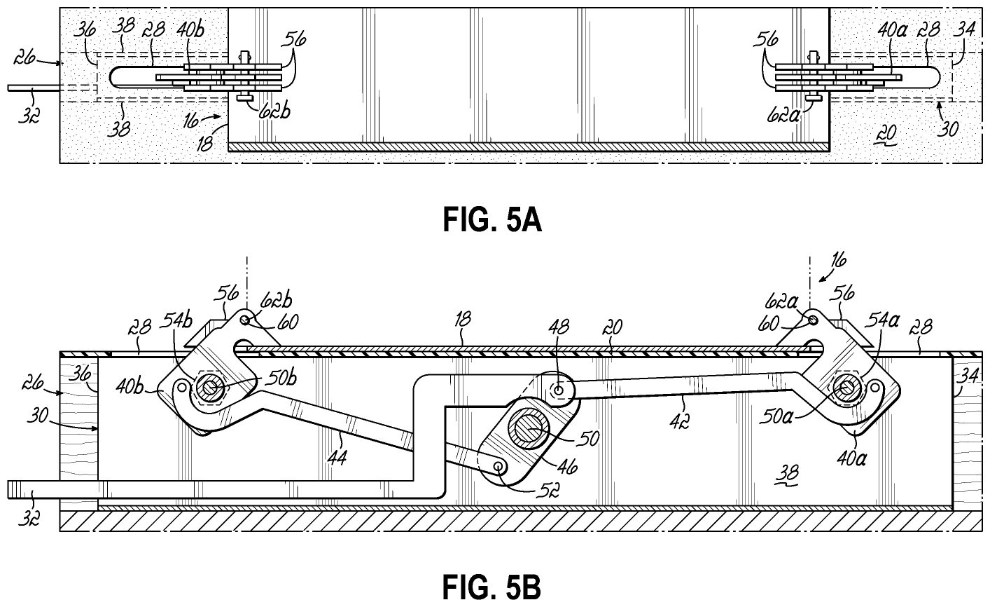

FIG. 5 shows a top view of the floor 20 of the vehicle 10 after the recessed locking mechanism 30 has been activated and the cargo 16 has been anchored in place. FIG. 5A shows a longitudinal top detail view of one of the cavities 26 that hosts a recessed locking mechanism 30 after the after the recessed locking mechanism has been activated and the cargo has been anchored in place. FIG. 5B shows a lateral detail view of the recessed locking mechanism 30 after the recessed locking mechanism 30 has been activated and the cargo 16 has been anchored in place. As can be seen in FIG. 5B, when the recessed locking mechanism 30 is activated, the locking claws 40a, 40b, emerge from respective slot 28s and align with corresponding locking plates 56. The locking claws 40a, 40b may emerge when a user pushes the arm 32 towards the first end 34 of the locking mechanism 30. This will cause the hub 46 to rotate on its axle 50 and the corresponding first and second linkage 42, 44, to move distally from the hub 46 toward the first end 34 of the vehicle 10. This forward movement of the first and second linkage 42, 44 causes the locking claws 40a, 40b to rotate on their respective axles 50a, 50b. The rotation of the locking claws 40a, 40b results in the locking claws 40a, 40b emerging from the cavity 26 through a slot 28.

In some embodiments, a different configuration may be utilized for activating the recessed locking mechanism 30. For example, rather than the user pushing the arm 32 toward the first end 34, a configuration may be implemented whereby the recessed locking mechanism 30 is activated by having the user push the arm 32 toward the second end 36, pull the arm 32 toward the first end 34, pull the arm 32 toward the second end 36, etc. By activating the recessed locking mechanism 30, each locking claw (e.g., locking claw 40a, 40b) aligns with a corresponding locking plate 56 whereby locking pins (e.g., locking pin 62a, 62b) can be inserted through the aligned locking apertures 58 and locking claw apertures 60.

In such embodiments, the first linkage 42 and/or the second linkage 44 may be designed to have an adjustable length. In one such embodiment, one or more of the locking claws 40a, 40b may be configured to emerge from one or more slots 28 positioned at different locations within the cavity 26, wherein the one or more slots 28 may be positioned within the cavity 26 between the hub 46 and the first end 34 for locking claw 40a, and wherein one or more slots 28 may be positioned within the cavity 26 between the second end 36 and the hub 46 for locking claw 40b (not shown). For example, an embodiment of the invention may include two slots 28 from which locking claw 40a or 40b may be configured to emerge such that a first slot 28 is positioned more distally to the hub 46 and a second slot 28 is positioned more proximally to the hub 46. In such an embodiment, the locking claw 40a or 40b may be configured to emerge from the first slot 28 when the first linkage 42 or the second linkage 44 respectively has a first length and the locking claw 40a or 40b may be configured to emerge from the second slot 28 when the first linkage 42 or the second linkage 44 respectively has a second length (not shown).

While two slots 28 and two lengths are described for the first linkage 42 and/or the second linkage 44, it is to be understood that this is provided by way of example. In practice, a different number of slots 28 may be cut into each respective cavity 26 (e.g., one slot 28, three slots 28, eight slots 28, etc.) and/or a different number of lengths may be possible for each linkage 42, 44 (e.g., one adjustable length, three adjustable lengths, eight adjustable lengths, etc.). In embodiments where both the first linkage 42 and the second linkage 44 have adjustable lengths, it is possible to adjust the first linkage 42 to have a different length than the second linkage 44 such that locking claw 40a is configured to emerge from a slot 28 more proximal to hub 46 than locking claw 40b or vice versa (not shown).

What is claimed is:

1. A locking mechanism for use in a vehicle, the locking mechanism comprising:
an arm;
a hub connected to the arm;
a linkage connected to the hub; and
a locking claw connected to the linkage, wherein operation of the arm causes a movement of the hub and a corresponding movement of the linkage, and wherein the corresponding movement of the linkage causes a change in a position of the locking claw, such that the locking claw emerges from or submerges into a cavity in a floor or a side wall of the vehicle.

2. The locking mechanism of claim 1, wherein the change in the position of the locking claw is a change from a first position within the cavity in the floor of the vehicle to a second position above the floor of the vehicle.

3. The locking mechanism of claim 1, wherein the change in the position of the locking claw is a change from a first position above the floor of the vehicle to a second position within the cavity in the floor of the vehicle.

4. The locking mechanism of claim 1, wherein the change in the position of the locking claw is from a first position within the cavity in the side wall of the vehicle to a second position outside of the cavity of the side wall of the vehicle.

5. The locking mechanism of claim 1, wherein the locking claw includes a locking claw aperture whereby a pin can be inserted through the locking claw aperture as well as through a corresponding locking aperture on a locking receiver so as to anchor a cargo in place.

6. The locking mechanism of claim 1, wherein operation of the arm creates a first force that causes the movement of the hub and the corresponding movement of the linkage, wherein the corresponding movement of linkage creates a second force that causes the change in the position of the locking claw.

7. The locking mechanism of claim 1, further comprising:
a second linkage connected to the hub; and
a second locking claw connected to the second linkage, wherein the operation of the arm causes the movement of the hub and a corresponding movement of the second linkage, and wherein the corresponding movement of the second linkage causes a change in a position of the second locking claw such that the second locking claw emerges from or submerges into the cavity in the floor of the vehicle.

8. A method for securing cargo in a vehicle, comprising:
operating an arm of a locking mechanism to secure the cargo in the vehicle, the locking mechanism including:
the arm;
a hub connected to the arm;
a linkage connected to the hub; and
a locking claw connected to the linkage,
wherein operating the arm causes a movement of the hub, and a corresponding movement of the linkage, and wherein the corresponding movement of the linkage causes a change in a position of the locking claw, such that the locking claw emerges from or submerges into a cavity in a floor of the vehicle.

9. The method of claim 8, further comprising:
placing a pin through a locking claw aperture of the locking claw and through a corresponding locking aperture on a locking receiver so as to anchor the cargo in place.

10. The method of claim 8, wherein operating the arm comprises:
pushing or pulling the arm of the locking mechanism to cause the locking claw to emerge from the cavity in the floor of the vehicle.

11. The method of claim 8, wherein operating the arm comprises:
pulling or pushing the arm of the locking mechanism to cause the locking claw to submerge into the cavity in the floor of the vehicle.

12. The method of claim 8, wherein the locking mechanism is a first locking mechanism, wherein the hub of the first locking mechanism connects to a first side of an axle and a hub of a second locking mechanism connects to a second side of the axle, and wherein operating the arm of the first locking mechanism activates both the first locking mechanism the second locking mechanism.

13. A locking system for securing cargo in a vehicle, the locking system comprising:
a locking receiver; and
a locking mechanism, comprising:
an arm;
a hub connected to the arm;
a linkage connected to the hub; and
a locking claw connected to the linkage, wherein operation of the arm causes a movement of the hub and a corresponding movement of the linkage, and wherein the corresponding movement of the linkage causes the locking claw to emerge from a cavity in a floor of the vehicle such that the locking claw aligns with the locking receiver.

14. The locking system of claim 13, wherein the locking receiver and a cargo are an integral piece.

15. The locking system of claim 13, wherein the locking receiver is a locking plate that is removably attached to a cargo.

16. The locking system of claim 13, wherein the hub of the locking mechanism connects to a first side of an axle, and wherein the locking system further comprises:
a second locking receiver; and
a second locking mechanism that includes:
a second hub that connects to a second side of the axle,
a second linkage connected to the second hub, and
a second locking claw connected to the second linkage, wherein operation of the arm causes a movement of the second hub and a corresponding movement of the second linkage, and wherein the corresponding movement of the second linkage causes the second locking claw to emerge from another cavity in the floor of the vehicle such that the second locking claw aligns with the second locking receiver.

17. The locking system of claim 13, wherein the locking claw includes a locking claw aperture whereby a pin can be inserted through the locking claw aperture as well as through a corresponding locking aperture on the locking receiver so as to anchor the cargo in place.
